(19) United States
(12) Patent Application Publication
(10) Pub. No.: US 2025/0312134 A1
(43) Pub. Date: Oct. 9, 2025

(54) APPARATUS, A SYSTEM INCLUDING THE APPARATUS AND A CAGE, AND A METHOD FOR EUTHANIZING LABORATORY ANIMALS HOUSING INSIDE THE CAGE

(71) Applicant: Xpromed GmbH, Köln (DE)

(72) Inventor: Johannes Wecker, Cologne (DE)

(73) Assignee: Xpromed GmbH, Köln (DE)

(21) Appl. No.: 18/627,652

(22) Filed: Apr. 5, 2024

(51) Int. Cl. A61D 7/04

(52) U.S. Cl. CPC A61D 7/04

(57) ABSTRACT

An apparatus, a system and a method for euthanizing laboratory animals, in particular rodents and lagomorphs, housed in a laboratory cage, the cage having a tub shaped body and an upper rim, wherein the apparatus comprises two sidewalls being arranged parallel to each other, a top panel, a leverage mechanism, and a gas unit for administering a euthanizing gas, wherein the top panel is positioned in between the two sidewalls, and connects the two sidewalls with each other, the top panel comprises at least one gas inlet and one gas outlet, the gas inlet and the gas outlet being connected to the gas unit.

### FIELD OF THE INVENTION

The invention relates to an apparatus for euthanizing laboratory animals, a system including the apparatus and a laboratory cage, and a method for euthanizing laboratory animals housed in the cage.

### BACKGROUND

The welfare of laboratory animals is important due to their ability to feel pain, suffering, and fear. For this reason, it is necessary to ensure the welfare of laboratory animals which are used or have been used in scientific procedures, by increasing the minimum standards for their protection.

The use of inappropriate euthanizing methods can cause significant pain, fear and suffering to a laboratory animal. Animals should therefore only be euthanized by appropriate methods which are suitable for the respective laboratory animal species. Animal protection rights place high demands on such euthanizing apparatus and euthanizing methods.

Exemplary, CO₂ is a respiratory stimulant and very quickly causes dyspnoea or shortness of breath in laboratory animals. Therefore, CO₂ is one of the most commonly used euthanizing gas in laboratory animals such as mice. However, CO₂ can lead to aversion and nociception, thus causes great stress for the animal.

It is the object of the invention to provide measures for euthanizing laboratory animals that reduce the stress for the laboratory animal during the entire process of euthanasia and that the laboratory animal loses its consciousness before the actual killing of the laboratory animal.

According to the present invention, the problem is solved by the features of the independent claims. The dependent claims describe embodiments of the invention which may be preferred under particular circumstances. Likewise, the specification describes further embodiments of the invention which may be preferred under particular circumstances.

### DETAILED DESCRIPTION OF THE EMBODIMENTS

Before the invention is described in detail, it is to be understood that this invention is not limited to the particular component parts of the devices described or process steps of the methods described, as such devices and methods may vary. It is also to be understood that the terminology used herein is for purposes of describing particular embodiments only and is not intended to be limiting. It must be noted that, as used in the specification and the appended claims, the singular forms “a”, “an”, and “the” include singular and/or plural referents unless the context clearly dictates otherwise. It is moreover to be understood that, in case parameter ranges are given which are delimited by numeric values, the ranges are deemed to include these limitation values.

The object is solved by an apparatus for euthanizing laboratory animals, in particular rodents and lagomorphs, housed in a laboratory cage, the cage having a tub shaped body and an upper rim, wherein the apparatus comprises two sidewalls being arranged parallel to each other, a top panel, a leverage mechanism, and a gas unit for administering a euthanizing gas, wherein the top panel is positioned in between the two sidewalls, and connects the two sidewalls with each other, the top panel comprises at least one gas inlet and one gas outlet, the gas inlet and the gas outlet being connected to the gas unit, wherein the leverage mechanism comprises two guiding rails, the guiding rails extending parallel to each other along a guiding rail axis, the guiding rails being arranged in between the two sidewalls, and being configured for inserting the upper rim of the cage and/or a ridge-like protrusion of the body into the guiding rails and for sliding the cage along the guiding rail axis into an end-position where at least a part of the body of the cage is arranged below the top panel, and wherein the leverage mechanism further comprises a lever, and is configured such that an actuation of the lever lifts the guiding rails towards the top panel, such that the upper rim of the cage being arranged in the end position abuts against the top panel.

The object is further solved by a system comprising the above described apparatus and a laboratory cage for housing laboratory animals, in particular rodents and lagomorphs, the cage having a tub shaped body and an upper rim, wherein a) the upper rim is configured for sliding in the guiding rails along the guiding rail axis of the apparatus, and/or b) the body comprises a ridge-like protrusion being configured for sliding in the guiding rails along the guiding rail axis of the apparatus.

The above object is further solved by a method for euthanizing laboratory animals, in particular rodents and lagomorphs, using the above system, wherein the laboratory animals are housed in the cage, comprising the steps of:
sliding the cage along the guiding rail axis into the end-position,
actuating the lever for lifting the guiding rails, and
establishing an atmosphere inside the cage being enriched with euthanizing gas by administering the euthanizing gas from the gas unit to the cage.

One aspect of the invention is thus, that the laboratory cage which is used for housing the laboratory animals can be directly used for euthanasia. It is therefore not necessary that the laboratory animals are transferred into a special container for euthanasia but can remain in the known home environment of the laboratory cage. Thus, stress in the animal during euthanasia can be reduced.

A further aspect of the invention is, that by virtue of the leverage mechanism the upper rim of the cage is brought into a position where it abuts against the top panel. Only in this position a euthanizing gas enriched atmosphere is established inside the cage by administering the euthanizing gas from the gas unit to the cage. Thus, this provides safe and economic means for euthanasia, as the euthanizing gas is directly provided into the cage and losses of euthanizing gas—and thus potential harm to the person operating the system—can be mitigated. A further aspect of the invention is that as the top panel comprises the gas inlet and gas outlet, the euthanizing gas enters the cage from above. This manner of administering the euthanizing gas causes less stress to the animals being housed in the cage.

Laboratory animals are small animals, typically rodents and lagomorphs, which are produced for or used in research, testing and teaching. Typically, laboratory animals are used extensively as experimental animal models in pharmaceutical and biomedical research.

The apparatus, the system, and the method have the advantage that euthanasia is performed in a manner that results in rapid unconsciousness of the laboratory animal followed by cardiac or respiratory arrest and ultimate loss of brain function of the laboratory animal with a minimum of pain, discomfort, and distress. Typically, the laboratory animals are euthanized at the end of an experiment or when research requires that tissue samples from sites such as heart, lung, liver, or brain need to be collected.

The euthanizing gas is a gas which leads to the death of the laboratory animals. Several euthanizing gases can be used in euthanizing, including anesthetic gases such as ether, chloroform, halothane, methodyfurane, enfurane, isofurane, cyclopane, nitrous acid or nonanesthetic gases such as carbon monoxide (CO), carbon dioxide (CO₂), Nitrogen (N₂), Argon or hydrogen cyanide.

As used herein, “parallel” means that the parts which are parallel are running in the same direction at about the same distance next to each other.

Preferably, the end position of the cage in the apparatus is a position along the guiding rail axis where the cage is arranged in the guiding rails either by the upper rim or by the ridge-like protrusion of the body and when lifted by the leverage mechanism the rim of the tub shape body abut against the top panel, such that the top panel of the apparatus and the cage form an essentially airtight unit. In other words, in the end position preferably the whole rim and not just a part of the rim is vertically below the area of the top panel, such that when the cage is lifted the whole rim and not just a part of the rim of the tub shaped body is in contact with the top panel. In case the body of the cage comprises the ridge-like protrusion, it is preferred that said protrusion extend on outer surfaces of two opposing sidewalls of the tub shaped body.

As used herein, airtight means that under standard conditions, more particularly standard air pressure, no euthanizing gas flows uncontrollably out or into the unit of the cage in between the contact area of the rim and the top panel. Standard refers to the pressure conditions present in the environment and are about 1 bar, about 14.5038 psi or about 100 kPa at around 298K, about 25° C. or about 77° F. It also refers to the slightly lower pressure or the slightly higher pressure which are common in laboratory environments.

Controlled gas flow in or out of the unit of the cage within the apparatus is primarily achieved by the gas inlet and the gas outlet that are arranged in an area being enclosed by the upper rim of the body abutting against the top panel.

According to a preferred embodiment of the invention, the top panel comprises a sealing, the sealing being arranged such that it matches the upper rim. As used herein, sealing means an element which is used to reduce leakage or containing a particular pressure in a system. The sealing preferably comprises a deformable material which is typically made of natural or non-natural polymers. The sealing makes it possible that the apparatus can also be used with cages having a top grill as upper lid, as it compensates for a potential unevenness of the upper rim, being caused by the top grill.

According to a further preferred embodiment of the disclosure, the sealing is arranged such that it seals the body of the cage against the top panel in a situation when the upper rim of the cage being arranged in the end position abuts against the top panel. In other words, the sealing covers at least the area of the upper panel, where the rim of the body abuts. It is possible that the sealing covers more than this area of the upper panel.

In connection to this and according to a further preferred embodiment of the disclosure, the sealing has a width of at least 4 mm, of at least 5 mm, of at least 6 mm, of at least 7 mm, of at least 8 mm.

Controlled gas flow out of the unit of the cage within the apparatus is achieved by the selection of the sealing having a specific height. The height of the sealing is preferably at least 1 mm, further preferably at least 2 mm, further preferably at least 3 mm, and even further preferably of at least 4 mm. The controlled gas flow out of the unit of the cage in its end position and lifted such that the rim abuts against the top panel through the contact area of the upper rim to the top panel ensures that when the euthanizing gas is administered, no intense pressure increase happens inside the cage. An intense increase in pressure would cause distress to the laboratory animals inside the cage.

In cases in which e.g., a top grill is used, and the top grill is hung onto to the upper rim, the sealing is adapted in height to form an air-tight system. Likewise, if the top lid extends the height of the upper rim, the sealing is adjusted accordingly to form an air-tight system.

According to another preferred embodiment of the disclosure, the sealing has a shore hardness, determined according to ASTM D2240 of any of the following:
45 shore 00 to 97 shore 00,
8 shore 0 to 79 shore 0,
5 shore A to 75 shore A,
6 shore B to 62 shore B,
9 shore C to 42 shore C,
6 shore D to 25 shore D.

The ASTM DM2240 is considered such a technical standard and describes the hardness of a material, typically of polymers. The hardness is measured by a shore durometer and the ASTM DM2240 technical standard calls for a total of 12 scales (A, B, C, D, E, M, O, OO, OOO, OOO-S and R) and each scale is further described by values ranging between 0 and 100 wherein the scale A is generally considered for softer hardness, while the scale D is considered a harder scale and wherein the value inside are considered harder with higher values.
The described values for the shore hardness of the sealing have the advantage that a controlled gas flow out of the unit of the cage within the apparatus when the rim abuts against the top panel is achieved when the euthanizing gas is administered. This prevents a sudden pressure increase in the cage, which would lead to discomfort in the laboratory animal.

According to another preferred embodiment of the disclosure, one or both of the gas inlet and gas outlet in the top panel has a diameter of at least 8 mm, preferably at least 9 mm, further preferably at least 10 mm, and even more preferably has a diameter of between 12 mm and 25 mm.

The flow rate of fluids such as gases is defined as the volume of the fluid passing through a particular point per unit time. In particular the flow rate depends on the diameter of the gas inlet and gas outlet so that a lower diameter leads to a higher flow rate and a higher diameter leads to a lower flow rate. A high flow rate of the gas would be perceived by the laboratory animal being housed in the cage as a recognizable and thus uncomfortable ventilation. A low flow rate of the gas would be disadvantageous when the specific atmosphere inside the cage needs to be established.

A diameter of at least 8 mm, preferably of at least 9 mm, and more preferably of at least 10 mm, more preferably of at least 11 mm, and even more preferably of at least 12 mm, and most preferably between 12 mm and 25 mm have been found to be advantageous for providing a flow rate which does not affect the laboratory animal negatively and ensuring an establishment of a euthanizing gas enriched atmosphere in a sufficient time.

According to one embodiment of the disclosure, the top panel comprises a sensor, wherein the sensor is configured for sensing a position where the upper rim of the body abuts against the top panel.

As used herein, sensor means a device that produces a signal for the purpose of detecting the position of the cage in the position where the cage is with reference to the guiding rail axis in its end position and lifted such that the upper rim abuts against the top panel. The sensor may directly detect the presence of the rim abutting against the top panel. Alternatively, the sensor may directly detect the presence of a lid of the cage or any other element of the cage. The output signal which is produced by the sensor can enable further operations of the apparatus such that only under specific conditions—e.g. when the rim and the top meet—the euthanizing gas is administered. The output signal may be further modulated so that it provides acoustic, visual, or haptic feedback to the operator of the apparatus, system, or method.

According to another preferred embodiment of the disclosure, the guiding rails comprise a latching element for securing the cage in the end-position. As used herein, a latching element is a mechanical composition in which a first element typically slides into, hooks into or snaps into a second element to temporarily prevent the joined parts moving relative to each other. Known latching elements are for instance spring latches. The latching element can also be configured as a recess in the guiding rail.

According to another preferred embodiment of the disclosure, one of the gas inlet or the gas outlet is arranged in a first third and the other is arranged in a last third of an area being enclosed by the upper rim of the body abutting against the top panel, the first and last third referring to an extent of the area along the guiding rail axis.

The gas inlet and gas outlet are each arranged in a different first or last third of the area. This arrangement enables that the euthanizing gas which enters the atmosphere inside the cage through the gas inlet must run through at least the middle third to eventually leave the atmosphere inside the cage through the gas outlet. This advantageous arrangement improves the fluid dynamics of the atmosphere inside the cage and thus improves the establishment of a euthanizing gas enriched atmosphere.

According to another preferred embodiment of the disclosure, the apparatus further comprises a lever which comprises a pin extending through a guiding slot of the sidewall for lifting the guiding rails towards the top panel, when actuating the lever.

As used herein, the guiding slot describes an opening in the sidewall, wherein the opening is configured to match the shape of the pin and match the movement of the pin when the lever is actuated. By matching both, the lifting is guided which leads to a more stable configuration of the lever, the guiding rails, and the sidewalls. Thus, the lifting of the cage does not cause any discomfort to the animals inside the cage.

According to another preferred embodiment of the disclosure, the apparatus comprises a lever which is rotationally connected to the sidewall. The rotational connection allows that the lever can move in a circular movement up and down. Preferably the lever is actuated downwards for movement of guiding rails upwards to allow an easy operation of the apparatus and the system by the operator.

According to another preferred embodiment of the disclosure, the apparatus comprises a lever wherein the lever is u-shaped, comprises a middle part being perpendicular to the sidewalls, and two outer parts being parallel to the sidewalls, wherein the sidewalls are arranged in between the two outer parts of the lever.

According to a further embodiment of the disclosure, each guiding rail comprises at least one pin extending through a further guiding slot of the sidewall guiding the movement of the guiding rails towards the top panel. As used herein, the guiding slot describes an opening or cavity in the sidewall, wherein the opening or cavity is configured to match the shape of the pin and matches the movement of the pin when the guiding rail is lifted. By matching both, the lifting is guided which leads to a more stable configuration of the lever, the guiding rails, and the sidewalls to allow for a vertical movement only.

According to another preferred embodiment of the disclosure, the gas unit of the apparatus comprises a mixing unit, wherein said mixing unit further comprises a first gas port being connected to the gas inlet, a second gas port being connected to the gas outlet, and a third gas port being connected to a gas supply of euthanizing gas. Through this measure, the apparatus and the system can be operated in such a way that the atmosphere is continuously or quasi-continuously removed from the cage, wherein to the atmosphere being removed from the cage euthanizing gas can be added, and the resulting euthanizing enriched atmosphere can be fed back into the cage. During this cycle process, the concentration of euthanizing gas in the cage is automatically increased. The concentration increase rate can then be selected based on the animal species and/or animal weight, and easily be controlled.

According to another preferred embodiment of the disclosure the gas unit is arranged on top of top panel to provide the minimum distance between the mixing unit and the cage.

According to a further preferred embodiment of the disclosure, the gas unit is configured such that euthanizing gas is provided via the first gas port to the laboratory cage upon receipt of a start signal from the sensor by the gas unit. This makes the apparatus safe for the operator as only in the condition when the rim abuts against the top panel, the euthanizing gas is administered. It is understood that the euthanizing gas is provided only when the cage is in its end position within the apparatus and lifted such that the rim abuts against the top panel. The start signal may be an initiating start signal or a continuous start signal.

According to another preferred embodiment of the disclosure, the apparatus comprises a gas unit which is configured such that euthanizing gas is not provided via the first gas port to the laboratory cage upon receipt of a stop signal. It is understood that the flow of the euthanizing gas is prevented when the cage is not in the end position within the apparatus or not lifted such that the rim abuts against the top panel. The stop signal may be, depending on the sensor the absence of the start signal.

As already mentioned, the invention also relates to the system comprising the apparatus as described herein and the cage for housing laboratory animals, in particular rodents and lagomorphs, the cage having the tub shaped body and the upper rim, wherein a) the upper rim is configured for sliding in the guiding rails along the guiding rail axis of the apparatus, and/or b) the body comprises a ridge-like protrusion being configured for sliding in the guiding rails along the guiding rail axis of the apparatus.

According to a preferred embodiment of the disclosure, the cage comprises gas-impermeable walls and a gas-impermeable bottom. Thus, any euthanizing gas administered to the cage cannot leave through the walls and the bottom. Typically, the walls are made of glass or plastic polymers.

According to another preferred embodiment of the disclosure, the cage of the system further comprises a gas-permeable upper lid being configured to fit on the body. The upper lid of the cage typically prevents that the animals in the cage can leave the cage. Furthermore, the apparatus is preferably configured such that the cage can be introduced into the apparatus for euthanizing the animals with the lid of the cage being fit on the body of the cage. Preferably when the upper lid is fit on the body, the upper lid does preferably not protrude over a height defined by the upper rim of body in an area enclosed by the upper rim. Thus, the lid being fit to the cage does preferably not prevent that the upper rim abuts against the top panel.

As used herein, the gas-permeable upper lid may comprise HEPA filters. HEPA (high-efficiency particulate air) filters are known air filters composed of corrugated internal structures which allow a pass-through of gases but not of particles with a certain diameter typically equal to 0.3 μm or less.

According to a further preferred embodiment of the disclosure, the upper lid is configured as a top grill. The top grill is preferably a grid-shaped cover which locks the laboratory animal inside the cage while allowing air entering the cage.

According to one embodiment of the disclosure, the system comprises an upper lid which is of a gas impermeable material, and has at least two windows arranged in a position corresponding to the position of the gas inlet and the gas outlet when the cage is positioned in the end-position. Thus, when the cage is lifted such that the rim abuts against the top panel, the euthanizing gas can enter the cage through the window.

The upper lid may comprise HEPA filter in at least two windows. In this case, the gas inlet and gas outlet are arranged in their position correspondingly to one or both of the windows and preferably in the first third and in a last third of the area enclosed by the rim.

According to another aspect of the disclosure, a method for euthanizing laboratory animals, in particular rodents and lagomorphs, using the system described herein is provided, wherein the laboratory animals are housed in the cage, comprises the steps of:
sliding the cage along the guiding rail axis into the end-position,
actuating the lever for lifting the guiding rails, and
establishing an atmosphere inside the cage being enriched with euthanizing gas by administering the euthanizing gas from the gas unit to the cage.

As used herein, enriching the atmosphere in the cage means that the concentration of the euthanizing gas increases in the atmosphere over time. The person skilled in the art knows how to select the proper atmosphere in respect to the laboratory animal.

Particularly preferably the step of sliding the cage along the guiding rail axis into the end-position, is performed with the upper lid of the cage being attached to the body. In other words, there is no need to remove the upper lid of the cage before inserting the cage into the apparatus.

According to a preferred embodiment of the disclosure, the method further comprises the steps of establishing an atmosphere inside the cage being enriched with euthanizing gas which are performed in a continuous or quasi-continuous process and comprise
a) extracting the atmosphere from inside the cage,
b) blending the extracted atmosphere with the euthanizing gas in the mixing unit,
c) establishing the euthanizing gas enriched atmosphere inside the cage by reintroducing the blended atmosphere back into the cage.

The increase of the euthanizing gas in the atmosphere inside the cage may be continuous or quasi-continuous. The person skilled in the art knows to select the proper atmosphere in respect to the laboratory animal.

According to a further preferred embodiment of the disclosure, the steps a) to c) are repeated to maintain the euthanizing gas enriched atmosphere inside the cage or to increase the euthanizing gas concentration in the enriched atmosphere.

According to one embodiment of the disclosure, the method comprises a further step of stopping the administration of the euthanizing gas from the gas unit to the cage by actuating the lever. This provides a very simple and effective way to interrupt the euthanasia process or to finish the process when death of the animal has been inflicted. The advantage of manually actuating the lever to stop the administration of the euthanizing gas enables the operator of the method to manually intervene if necessary e.g., in cases when the laboratory animal suffers from malfunctions during euthanizing.

Further technical effects and associated advantages of the present apparatus, system and method will be apparent to those skilled in the art from the following description of the drawings.

The invention is explained below by way of example with reference to the accompanying drawings using preferred exemplary embodiments, whereby the features shown below can represent an aspect of the invention both individually and in combination:

### DESCRIPTION OF THE FIGURES

In the drawings:

FIG. 1: shows a schematic perspective view of an apparatus for euthanizing laboratory animals according to a preferred embodiment of the invention,

FIG. 2: shows a schematic perspective view of the apparatus of FIG. 1,

FIG. 3: shows a schematic side view of an apparatus for euthanizing laboratory animals according to a second embodiment of the invention,

FIG. 4: shows a schematic view from below of a top panel of the apparatus of FIG. 3,

FIGS. 5a), and b): show a schematic view of the apparatus of FIG. 3 during actuation of a lever,

FIG. 6: shows a schematic view of a gas unit of an apparatus for euthanizing laboratory animals according to a further embodiment of the invention,

FIG. 7: shows a schematic view of a gas unit of an apparatus for euthanizing laboratory animals according to a further preferred embodiment of the invention,

FIG. 8: shows a schematic view of a system comprising a laboratory cage and the apparatus of FIG. 1 according to a preferred embodiment of the invention, and

FIG. 9: shows a schematic view of a system comprising a laboratory cage and the apparatus of FIG. 3 according to a further preferred embodiment of the invention.

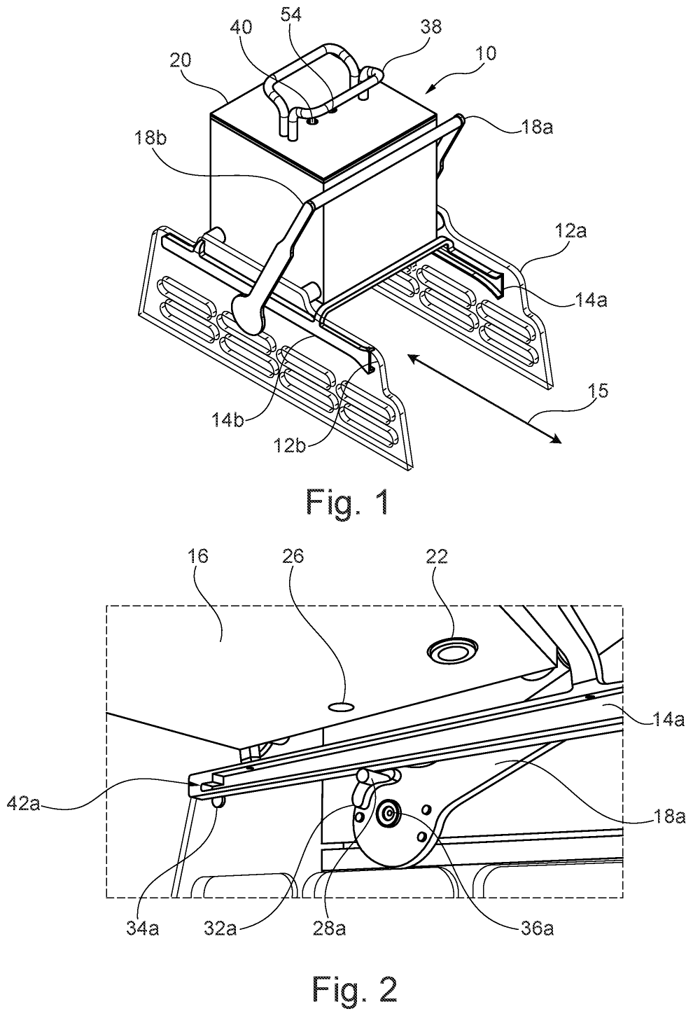

FIGS. 1 and 2 show schematic perspective views of an apparatus 10 for euthanizing laboratory animals according to a preferred embodiment of the invention. Features that are present on the right side of the apparatus and the left side of the apparatus in a similar fashion are indicated with “a” and “b” in the figures. The apparatus 10 comprises two sidewalls 12a, 12b being arranged parallel to each other, a top panel 16, a leverage mechanism, and a gas unit 20 for administering a euthanizing gas. In this embodiment the top panel 16 is formed by the bottom of the gas unit 20. The top panel 16 is positioned in between the two sidewalls 12a and 12b, and connects the two sidewalls 12a, and 12b with each other.

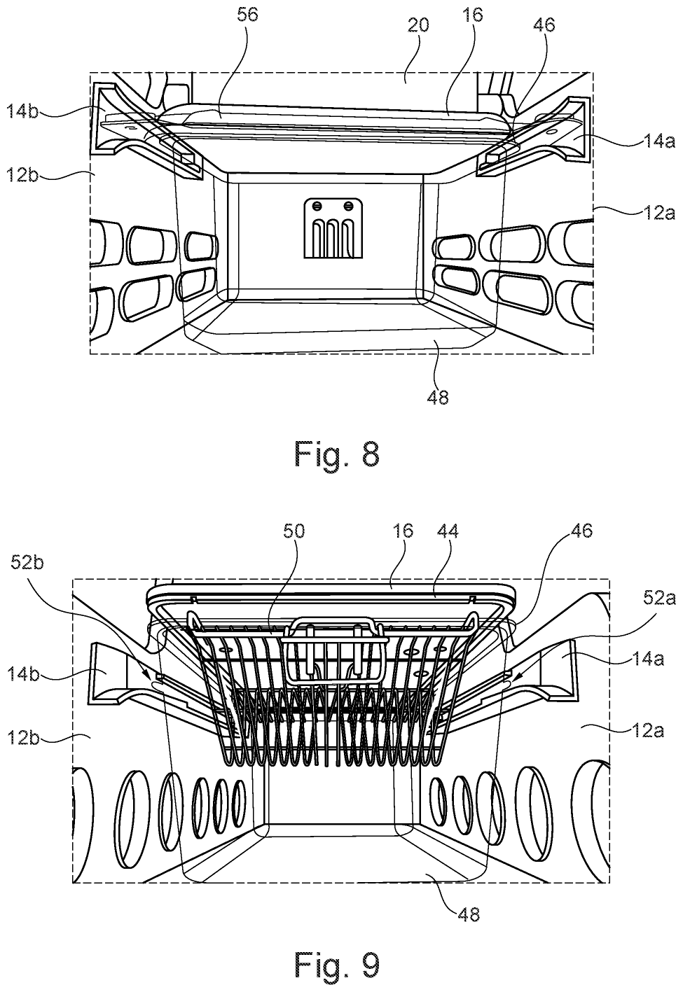

The leverage mechanism of the apparatus 10 comprises two guiding rails 14a, 14b, the guiding rails 14a, 14b extending parallel to each other along a guiding rail axis 15, the guiding rails 14a, 14b being arranged in between the two sidewalls 12a, 12b. In this embodiment the guiding rails 14a, 14b are configured for inserting an upper rim 46 of a cage 48 (cage 48 with rim 46 not seen in FIGS. 1 and 2, but in FIG. 8) into the guiding rails 14 and for sliding the cage 48 along the guiding rail axis 15 into an end-position where at least a part of the body of the cage 48 is arranged below the top panel 16.

The leverage mechanism further comprises a lever 18, and is configured such that an actuation of the lever 18 lifts the guiding rails 14 towards the top panel 16, such that the upper rim 46 of the cage 48 being arranged in the end position abuts against the top panel 16. As can be seen in FIG. 2, the top panel 16 comprises at least one gas inlet 22. The top panel 16 further comprises one gas outlet 24 (not shown in FIG. 2), the gas inlet 22 and the gas outlet 24 being connected to the gas unit 20. As is also visible in FIG. 2, is that the top panel 16 comprises a sensor 26, wherein the sensor 26 is configured for sensing a position where the upper rim 46 abuts against the top panel 16. In this embodiment the gas unit 20 is configured such that euthanizing gas is provided via the first gas port 22 to the cage 48 upon receipt of a start signal from the sensor 26.

As can further be seen on FIG. 1, the apparatus 10 comprises on the gas unit 20 a transportation handle 38, a gas port 40 for connecting the gas unit 20 to a gas supply of euthanizing gas, and a power connection 54. Furthermore, it is visible in FIG. 2 that the lever 18 is rotationally connected 36 to the side walls 12 and comprises a pin 28 reaching through a guiding slot 32 in the sidewall, for pushing the guiding rail 14 upwards, when the lever 18 is actuated downwards. Additionally, also the guiding slot 34 in the sidewall 12 for guiding the guiding rail 14 in its vertical movement is shown in FIG. 1. FIG. 1 further shows that the guiding rails 14 comprise a latching element 42 configured as a recess for securing the cage 48 in the end-position.

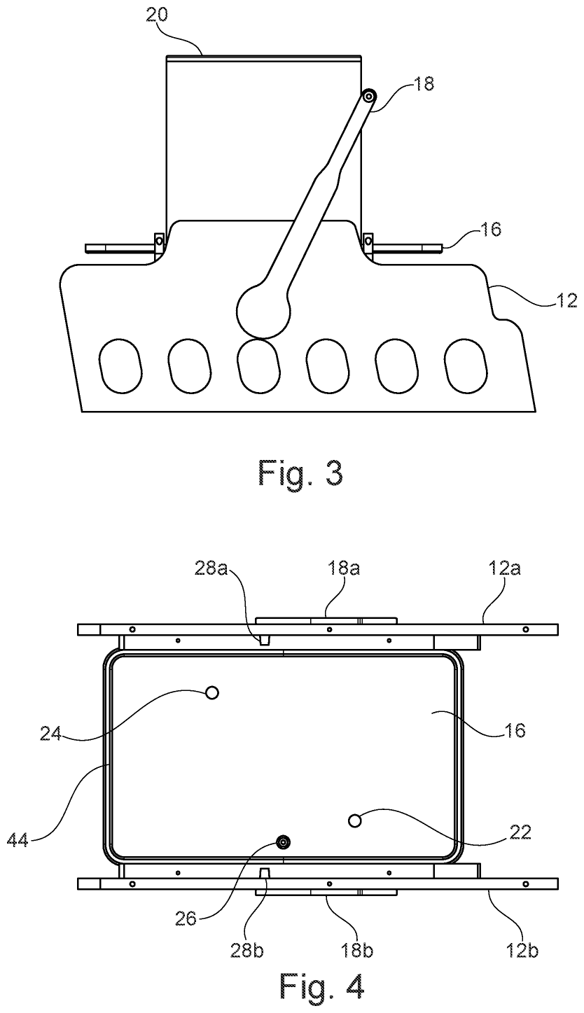

FIGS. 3 and 4 show schematic perspective views of an apparatus 10 for euthanizing laboratory animals according to another preferred embodiment of the invention. As well as the first embodiment shown in FIGS. 1 and 2, the apparatus 10 of FIGS. 3 and 4 comprises two sidewalls 12a, 12b being arranged parallel to each other, a top panel 16 a leverage mechanism, and a gas unit 20 for administering a euthanizing gas. In this embodiment the top panel 16 is larger than the bottom of the gas unit 20. The top panel 16 is positioned in between the two sidewalls 12a and 12b, and connects the two sidewalls 12a, and 12b with each other.

The leverage mechanism of the apparatus 10 comprises two guiding rails 14a, 14b, the guiding rails 14a, 14b extending parallel to each other along a guiding rail axis 15, the guiding rails 14a, 14b being arranged in between the two sidewalls 12a, 12b. In this embodiment the guiding rails 14a, 14b are configured for inserting a ridge-like protrusion 52 of the body of a cage 48 (cage 48 and ridge-like protrusion 52 not seen in FIGS. 3 and 4, but in FIG. 9) into the guiding rails 14 and for sliding the cage 48 along the guiding rail axis 15 into an end-position where at least a part of the body of the cage 48 is arranged below the top panel 16.

As can be best seen in FIG. 4, the top panel 16 comprises the gas inlet 22, the gas outlet 24 and the sensor 26. Additionally, the top panel 16 also comprises a sealing 44. The sealing 44 is arranged such that it seals the body of the cage 48 against the top panel 26 in a situation when the upper rim 46 of the cage 48 being arranged in the end position abuts against the top panel 16. Furthermore, with regard to the guiding rail axis 15, one of the gas inlet 22 or the gas outlet 24 is arranged in a first third and the other is arranged in a last third of the area being enclosed by the sealing 44.

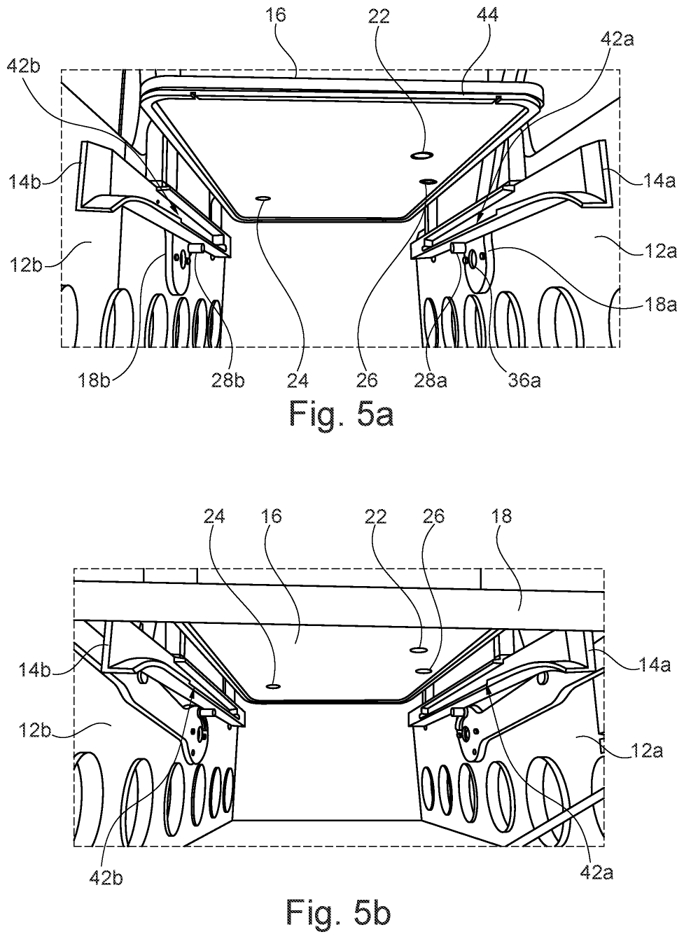

FIGS. 5a) and 5b) are a schematic view of the apparatus 10 of FIG. 3 during actuation of the lever 18. As can be seen in FIG. 5a) which shows a situation where the lever 18 is in an initial position a distance between the guiding rails 14 to the top panel 16 is higher as in FIG. 5b) which shows a situation where the lever 18 has been pushed downwards.

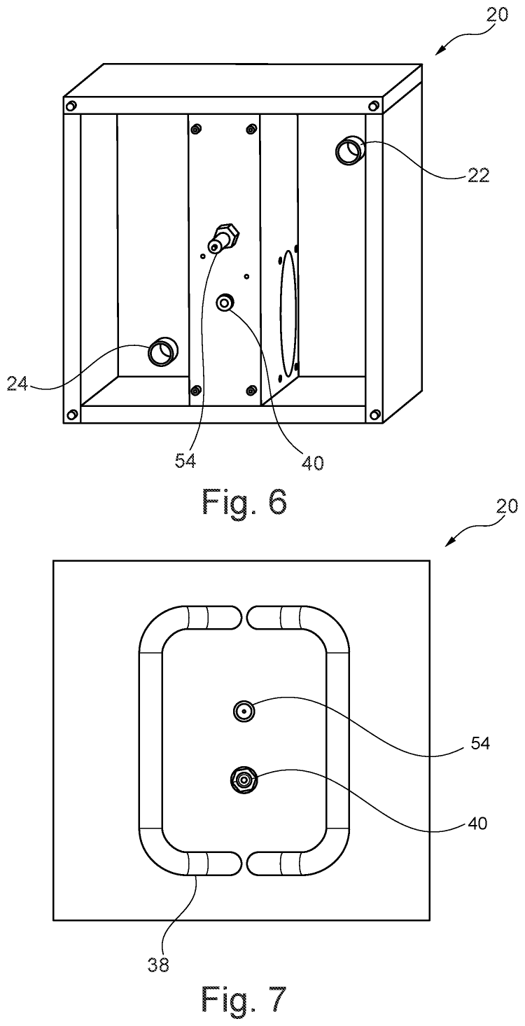

FIGS. 6 and 7 are schematic views of a gas unit 20 of an apparatus 10 for euthanizing laboratory animals according to a further preferred embodiment of the invention. FIG. 6 shows the inner structure of the gas unit 20, while FIG. 7 shows the outer surface with the gas port 40 for connecting the gas unit 20 to the external gas supply of euthanizing gas. Furthermore, the transportation handle 38 and the power connection 54 are shown. FIG. 6 shows that within the gas unit 20 there is a mixing chamber, where the gas being fed into the gas unit 20 from the cage 48 via the gas inlet 22 is mixed with the euthanizing gas being fed into the gas unit 20 via the gas port 40 and then the euthanizing enriched atmosphere is than resupplied into the cage 48 via the gas outlet 24.

FIG. 8 is a schematic view of a system comprising the laboratory cage 48 and the apparatus 10 of FIG. 1 according to a preferred embodiment of the invention. As is visible in FIG. 8, the apparatus 10 can be used with a cage 48 having a lid 56. FIG. 8 shows a situation where the cage 48 has been inserted with its upper rim 46 into the guiding rail 14 and the lever 18 has been actuated. Thus, the upper rim 46 of the cage 48 in this particular embodiment being formed by the lid 56 abuts against the top panel 16.

FIG. 9 is a schematic view of a system comprising the laboratory cage 48 and the apparatus 10 of FIG. 3 according to a preferred embodiment of the invention. As is visible in FIG. 9, the apparatus 10 can be used with a cage 48 having a lid 56 being configured as a top grill 50. FIG. 9 shows a situation where the cage 48 has been inserted with its ridge-like protrusion 52 into the guiding rail 14. However, the lever 18 has not yet been fully actuated. Thus, the upper rim 46 of the cage 48 does not yet abut against the top panel 16.

The system shown in FIG. 8 as well as the system shown in FIG. 9 are both configured to be used in a method for euthanizing laboratory animals being housed in the cage 48, comprising the steps of:
sliding the cage 48 along the guiding rail axis 15 into the end-position,
actuating the lever 18 for lifting the guiding rails 14, and
establishing an atmosphere inside the cage 48 being enriched with euthanizing gas by administering the euthanizing gas from the gas unit 20 to the cage 48.

It is to be understood that features discussed with one embodiment are meant to be disclosed also in connection with other embodiments shown herein. If, in one case, a specific feature is not disclosed with one embodiment, but with another, the skilled person would understand that this does not necessarily mean that said feature is not meant to be disclosed with said other embodiment.

### Reference Signs

10 apparatus
12 side wall
14 guiding rail
15 guiding rail axis
16 top panel
18 lever
20 gas unit
22 gas inlet
24 gas outlet
26 sensor
28 pin (lever)
30 pin (guiding rail)
32 guiding slot (lever)
34 guiding slot (guiding rail)
36 rotational connection
40 gas port (external)
42 latching element
44 sealing
46 upper rim
48 cage
50 top grill
52 ridge-like protrusion
54 power connection
56 lid

1. Apparatus for euthanizing laboratory animals, in particular rodents and lagomorphs, housed in a laboratory cage, the cage having a tub shaped body and an upper rim, wherein the apparatus comprises
two sidewalls being arranged parallel to each other, a top panel, a leverage mechanism, and a gas unit for administering a euthanizing gas,
wherein the top panel is positioned in between the two sidewalls, and connects the two sidewalls with each other, the top panel comprises at least one gas inlet and one gas outlet, the gas inlet and the gas outlet being connected to the gas unit,
wherein the leverage mechanism comprises two guiding rails, the guiding rails extending parallel to each other along a guiding rail axis, the guiding rails being arranged in between the two sidewalls, and being configured for inserting the upper rim of the cage into the guiding rails and/or a ridge-like protrusion of the body into the guiding rails and for sliding the cage along the guiding rail axis into an end-position where at least a part of the body of the cage is arranged below the top panel,
wherein the leverage mechanism further comprises a lever, and is configured such that an actuation of the lever lifts the guiding rails towards the top panel, such that the upper rim of the cage being arranged in the end position abuts against the top panel.

2. Apparatus according to claim 1, wherein the top panel comprises a sealing, the sealing being arranged such that it matches the upper rim.

3. Apparatus according to claim 2, wherein the sealing is arranged such that it seals the body of the cage against the top panel in a situation when the upper rim of the cage being arranged in the end position abuts against the top panel.

4. Apparatus according to claim 2, wherein the sealing has a width of at least 4 mm, preferably a width of at least 8 mm.

5. Apparatus according to claim 2, the sealing has a height of at least 1 mm, preferably a height of at least 3 mm.

6. Apparatus according to claim 2, wherein the sealing has a shore hardness, determined according to ASTM D2240 of any of the following:
45 shore 00 to 97 shore 00,
8 shore 0 to 79 shore 0,
5 shore A to 75 shore A,
6 shore B to 62 shore B,
9 shore C to 42 shore C,
6 shore D to 25 shore D.

7. Apparatus according to claim 1, wherein one or both of the gas inlet and gas outlet in the top panel has a diameter of at least 8 mm, preferably has a diameter of between 12 mm and 25 mm.

8. Apparatus according to claim 1, wherein the top panel comprises a sensor, wherein the sensor is configured for sensing a position where the upper rim of the cage abuts against the top panel.

9. Apparatus according to claim 1, wherein the guiding rails comprises a latching element for securing the cage in the end-position.

10. Apparatus according to claim 1, wherein one of the gas inlet or the gas outlet is arranged in a first third and the other is arranged in a last third of an area being enclosed by the upper rim of the cage abutting against the top panel, the first and last third referring to an extent of the area along the guiding rail axis.

11. Apparatus according to claim 1, wherein the lever comprises a pin extending through a guiding slot of the sidewall for lifting the guiding rails towards the top panel, when actuating the lever.

12. Apparatus according to claim 1, wherein the lever is rotationally connected to the sidewall.

13. Apparatus according to claim 1, wherein the lever is u-shaped, comprises a middle part being perpendicular to the sidewalls, and two outer parts being parallel to the sidewalls, wherein the sidewalls are arranged in between the two outer parts of the lever.

14. Apparatus according to claim 1, wherein each guiding rail comprises at least one pin extending through a further guiding slot of the sidewall guiding the movement of the guiding rails towards the top panel.

15. Apparatus according to claim 1, wherein the gas unit comprises a mixing unit, wherein said mixing unit further comprises a first gas port being connected to the gas inlet, a second gas port being connected to the gas outlet, and a third gas port being connected to a gas supply of euthanizing gas.

16. Apparatus according to claim 8, wherein the gas unit is configured such that euthanizing gas is provided via the first gas port to the cage upon receipt of a start signal from the sensor by the gas unit.

17. System comprising the apparatus according to claim 1 and a laboratory cage for housing laboratory animals, in particular rodents and lagomorphs, the cage having a tub shaped body and an upper rim, wherein a) the upper rim is configured for sliding in the guiding rails along the guiding rail axis of the apparatus, and/or b) the body comprises a ridge-like protrusion being configured for sliding in the guiding rails along the guiding rail axis of the apparatus.

18. System according to claim 1, wherein the tub shaped body of the cage comprises gas-impermeable walls and a gas-impermeable bottom.

19. System according to claim 17, wherein the cage further comprises a gas-permeable upper lid being configured to fit on the body.

20. System according to claim 1, wherein the upper lid is configured as top grill.

21. System according to claim 19, wherein the upper lid is of a gas impermeable material and has at least two windows arranged in a position corresponding to the position of the gas inlet and the gas outlet when the cage is positioned in the end-position.

22. Method for euthanizing laboratory animals, in particular rodents and lagomorphs, using a system according to claim 17, wherein the laboratory animals are housed in the cage, comprising the steps of:
sliding the cage along the guiding rail axis into the end-position,
actuating the lever for lifting the guiding rails, and
establishing an atmosphere inside the cage being enriched with euthanizing gas by administering the euthanizing gas from the gas unit to the cage.

23. Method according to claim 22, wherein the step of establishing an atmosphere inside the cage being enriched with euthanizing gas is performed in a continuous or quasi-continuous process and comprises,
a. extracting the atmosphere from inside the cage,
b. blending the extracted atmosphere with the euthanizing gas in the mixing unit,
c. establishing the euthanizing gas enriched atmosphere inside the cage by reintroducing the blended atmosphere back into the cage.

24. Method according to claim 23, wherein the steps a) to c) are repeated to maintain the euthanizing gas enriched atmosphere inside the cage or to increase the euthanizing gas concentration in the enriched atmosphere.

25. Method according to claim 22, wherein the method comprises the further step of stopping the administration of the euthanizing gas from the gas unit to the cage by actuating the lever.
